(19) United States
(12) Patent Application Publication
(10) Pub. No.: US 2022/0198142 A1
(43) Pub. Date: Jun. 23, 2022

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventor: Akira FUNATSU, Kanagawa (JP)

(73) Assignee: FUJIFILM Business Innovation Corp., Tokyo (JP)

(21) Appl. No.: 17/337,438

(22) Filed: Jun. 3, 2021

(30) Foreign Application Priority Data
Dec. 23, 2020 (JP) 2020-213147

(51) Int. Cl. G06F 40/279; G06F 3/0484

(52) U.S. Cl. CPC G06F 40/279; G06F 3/0484

(57) ABSTRACT

An information processing apparatus includes a processor configured to receive an input of content of work including plural processes, and display a first process corresponding to the input content of the work and a second process estimated from work related to the content of the work and not included in the content of the work, on a display device.

### CROSS-REFERENCE TO RELATED APPLICATIONS

This application is based on and claims priority under 35 USC 119 from Japanese Patent Application No. 2020-213147 filed Dec. 23, 2020.

### BACKGROUND

### (i) Technical Field

The present invention relates to an information processing apparatus and a non-transitory computer readable medium storing a program.

### (ii) Related Art

Flow of a series of processes, which is constructed after receiving an input about work content from a user and based on processes in the received work content, is presented to the user.

JP2020-42656A discloses an information processing apparatus that receives an input of a natural sentence describing content of a process for a process target, generates a series of processes according to the received natural sentence, and displays content information indicating content of the generated series of processes.

JP2020-42658A discloses an information processing apparatus includes means for constructing a process flow, such as a workflow, from a natural sentence by receiving the natural sentence about the process flow, and means for arranging display objects, which are representative images of each process, to construct the process flow, and switches between which means to construct the process flow.

### SUMMARY

In a case where flow of a series of processes according to work content input by a user is constructed, and there is a process that is necessary for the work but is not recognized by the user, in some cases, the process necessary to perform the work is omitted in the constructed flow of a series of processes.

Aspects of non-limiting embodiments of the present disclosure relate to an information processing apparatus and a non-transitory computer readable medium storing a program that present, to a user, a process necessary to perform work other than a process of an input content of the work in a case where the input of the content of the work including a plurality of processes is received from the user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to receive an input of content of work including a plurality of processes, and display a first process corresponding to the input content of the work and a second process estimated from work related to the content of the work and not included in the content of the work, on a display device.

### BRIEF DESCRIPTION OF THE DRAWINGS

Exemplary embodiment (s) of the present invention will be described in detail based on the following figures, wherein:

FIG. 1 is a diagram showing a configuration of an information processing apparatus according to the present exemplary embodiment;

FIG. 2 is a diagram showing a functional configuration of the information processing apparatus;

FIG. 3 is a flowchart illustrating an operation related to display of a UI screen by the information processing apparatus;

FIG. 4 is a diagram showing an example of a management table used for managing extended functions and keywords;

FIG. 5 is a diagram showing an example of a management table used for managing work;

FIG. 6 is a flowchart illustrating a display operation of a message sentence of a presentation reason by the information processing apparatus;

FIG. 7 is a diagram showing a configuration example of the UI screen;

FIG. 8 is a diagram showing a display example of the UI screen in a case where a designation operation of a keyword is performed by a user;

FIG. 9 is a diagram showing a display example of the UI screen displaying a presentation reason of a second process; and

FIG. 10 is a diagram showing a display example of the UI screen on which annotations are displayed.

### DETAILED DESCRIPTION

Hereinafter, an exemplary embodiment of the present invention will be described in detail with reference to the accompanying drawings.

Apparatus Configuration

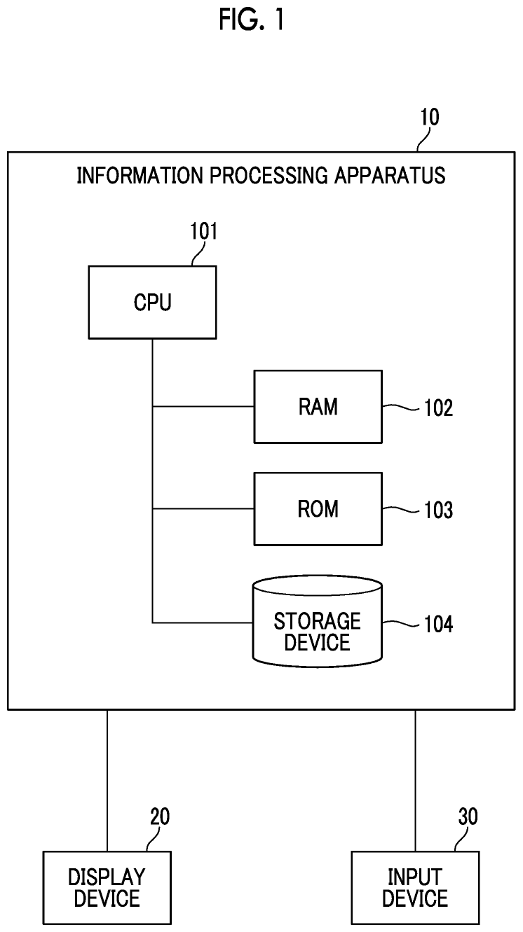

FIG. 1 is a diagram showing a configuration of an information processing apparatus according to the present exemplary embodiment. An information processing apparatus 10 is an apparatus that receives an input of content of a task by a user and presents a function for executing a process according to the input content of the task. As the information processing apparatus 10, for example, a personal computer is used. A display device 20 and an input device 30 are connected to the information processing apparatus 10. The display device 20 is a device that displays various screens for the information processing apparatus 10 to present information to the user or receive operations by the user. As the display device 20, for example, a liquid crystal display or an organic electro luminescence (EL) display is used. The input device 30 is a device for the user to perform an input operation of data or commands. As the input device 30, for example, a keyboard for inputting text or a pointing device for selecting or designating a specific place or display on the screen of the display device 20 is used. Examples of the pointing device include a mouse or a touch panel.

The information processing apparatus 10 includes a central processing unit (CPU) 101 that is a calculation unit, a random access memory (RAM) 102, a read only memory (ROM) 103, and a storage device 104 that are storage units. The RAM 102 is a main storage device (main memory), and is used as a task memory while the CPU 101 performs a calculation process. The ROM 103 preserves a program or data, such as a set value that is prepared in advance, and the CPU 101 may execute a process by directly reading the program or the data from the ROM 103. The storage device 104 is a unit that preserves a program and or data. The storage device 104 stores a program, and the CPU 101 reads the program stored in the storage device 104 to the main storage device and executes the program. A result of a process executed by the CPU 101 is stored and preserved in the storage device 104. As the storage device 104, for example, a magnetic disk device or a solid state drive (SSD) is used.

Functional Configuration of Information Processing Apparatus

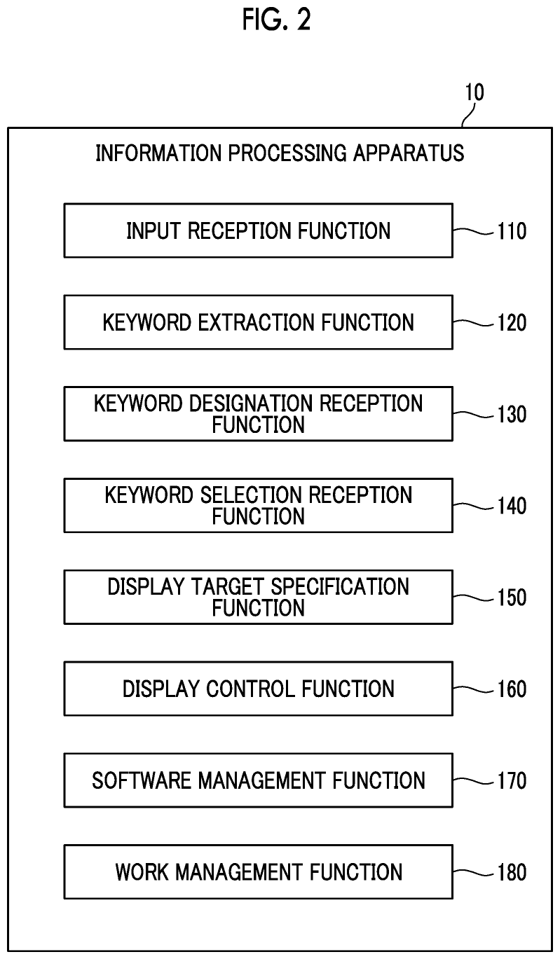

FIG. 2 is a diagram showing a functional configuration of the information processing apparatus 10. The information processing apparatus 10 has an input reception function 110, a keyword extraction function 120, a keyword designation reception function 130, a keyword selection reception function 140, a display target specification function 150, a display control function 160, a software management function 170, and a work management function 180. These functions are realized by, for example, the CPU 101 shown in FIG. 1 executing a program.

The input reception function 110 is a function of receiving an input of task information, which is information showing the content of the task related to work. Here, the work is performed by executing a plurality of predetermined tasks. In the following description, routine work in which a series of a plurality of tasks are executed in a time-series manner is assumed as an example of the work. In addition, an individual task related to the work may be called as a process. The input of the task information is performed, for example, by the user operating the input device 30 using a user interface screen (hereinafter, referred to as “UI screen”) displayed on the display device 20 under control of the information processing apparatus 10. In the present exemplary embodiment, the task information is input as a natural sentence. A specific input operation is performed, for example, by the user operating the keyboard, which is the input device 30, and inputting a natural sentence indicating task information in an input field for inputting task information on the UI screen displayed on the display device 20. The UI screen will be described in detail below.

The keyword extraction function 120 is a function of extracting a keyword from the input task information. The keyword extracted by the keyword extraction function 120 is a text string associated with an extended function for executing the task related to the work. In other words, in a case where the natural sentence of the input task information includes a text string corresponding to the keyword associated with the extended function, that keyword is extracted from the task information. Here, the extended function is realized by, for example, a software module, such as a so-called plug-in. Correspondences between the extended functions and the keywords are managed by the software management function 170. The software module that realizes the extended function may be stored and preserved in the storage device 104 shown in FIG. 1, or may be preserved in an external device and acquired from the external device as needed.

The keyword designation reception function 130 is a function of receiving a keyword designation by the user. The user may operate the input device 30 to designate a text string with respect to a text string that is not extracted as a keyword by the keyword extraction function 120 in the input natural sentence of the task information. Then, the text string designated by the user operation is received as a keyword candidate by the keyword designation reception function 130. A specific designation operation of the text string is performed, for example, by the user operating the pointing device, which is the input device 30, and selecting a text string of the natural sentence input in the input field on the UI screen displayed on the display device 20.

The keyword selection reception function 140 is a function of receiving a selection by the user regarding the keyword extracted from the input task information. The details will be described below, but the keyword selected by the user and received by the keyword selection reception function 140 is excluded from the keywords specified in the input task information. The keyword to be selected may include the keyword designated by the keyword designation reception function 130 in addition to the keyword extracted by the keyword extraction function 120. A specific selection operation of the keyword is performed, for example, by the user operating the pointing device, which is the input device 30, and designating the text string extracted as the keyword among the text strings of the natural sentence input in the input field on the UI screen displayed on the display device 20.

The display target specification function 150 is a function of specifying a process to be presented to the user. The process to be presented is specified based on the input task information. The specified processes are of two types, a first process and a second process. The first process is a process executed by the extended function associated with the keyword extracted from the input task information. In other words, the first process is a process corresponding to the content of the work indicated by the input task information. The second process is a process not corresponding to the first process but is estimated from the work indicated by the input task information. In a case where a process is one of a series of the processes executed in the work shown by the input task information, but a keyword associated with the extended function the executes the process is not included in the keywords extracted from the input task information, the process is set as the second process. Further, in a case where the extended function corresponding to the keyword designated by the keyword designation reception function 130 exists, a process executed by the extended function may be added to the second process. The specified process is displayed on the UI screen so as to be presented. A specific display method of the process will be described below.

The display control function 160 is a function of controlling the display of the UI screen on the display device 20. The UI screen is a screen that receives the input of task information and displays the input task information and a presentation target process specified by the display target specification function 150. Further, the UI screen is an operation screen for receiving various operations related to the input task information or the displayed presentation target process.

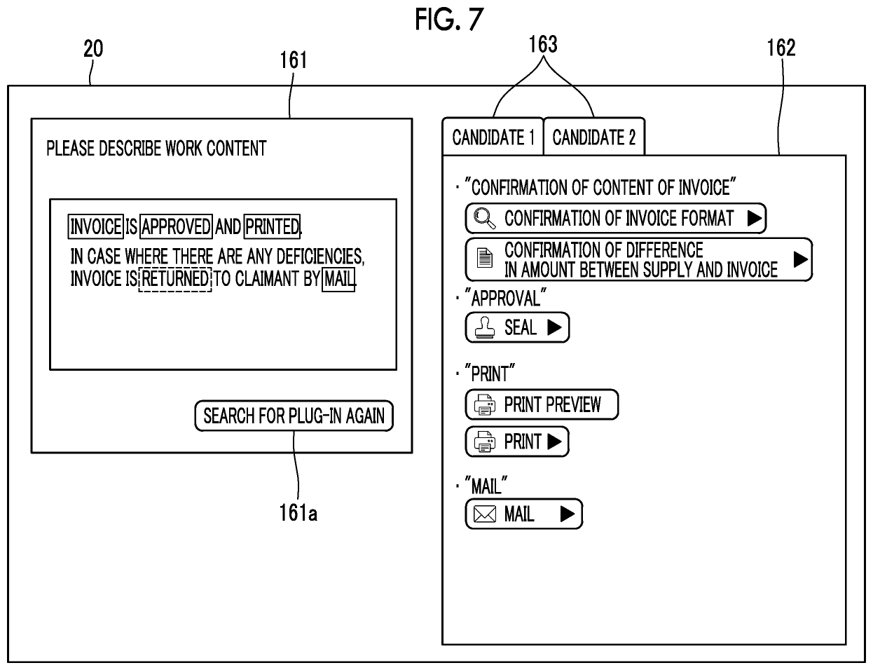

FIG. 7 is a diagram showing a configuration example of the UI screen. The UI screen displayed on the display device 20 is provided with an input field 161 and a process candidate display field 162. In the input field 161, the task information is input. In the process candidate display field 162, the process corresponding to the keyword extracted from the task information input in the input field 161 and the keyword designated by the user are displayed. The process displayed in the process candidate display field 162 is a process estimated to be executed from the work specified based on the task information input in the input field 161. In other words, the displayed process is a candidate of a process to be executed to perform the work specified based on the task information. In the following description, each process displayed in the process candidate display field 162 is referred to as a “process candidate”. Since the work includes a plurality of tasks, there are a plurality of process candidates estimated from the work specified based on the task information. In the following description, a set of the process candidates estimated from the work specified based on the task information is referred to as a “process candidate group”. In a case where a plurality of process candidate groups are estimated from the work specified based on the task information, the process candidate groups are displayed set by set in the process candidate display field 162. Switching the display between the process candidate groups is performed by selecting tabs 163. A specific display content of each display field and details of the operation in the UI screen will be described below.

The software management function 170 is a function of managing the extended functions and the keywords in association with each other. In a case where a keyword is newly set for any of the extended function or in a case where a keyword is set for a newly introduced extended function, the software management function 170 registers and manages a new correspondence between the extended function and the keyword.

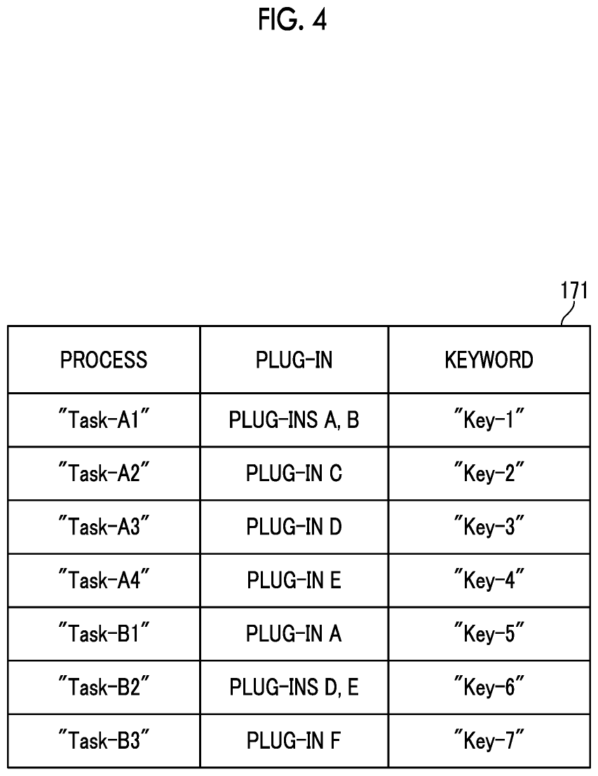

FIG. 4 is a diagram showing an example of a management table used for managing the extended functions and the keywords. In a management table 171 shown in FIG. 4, the name of the process, the plug-in that is the software module that realizes the extended function, and the keyword are registered in association with each other for each process executed by the extended function. For example, in order to execute a process “Task-A1”, the extended functions provided by the plug-in A and the plug-in B are required, and a keyword “Key-1” is associated with the process and the extended function. The management table 171 is stored and preserved in, for example, the storage device 104 shown in FIG. 1.

The work management function 180 is a function of managing the work including a plurality of tasks. In the present exemplary embodiment, routine work is assumed as the work. In the routine work, a plurality of tasks are executed according to a fixed task procedure defined by a workflow. Therefore, the work management function 180 manages tasks executed for each work and an execution order of each task regarding the work registered to be managed.

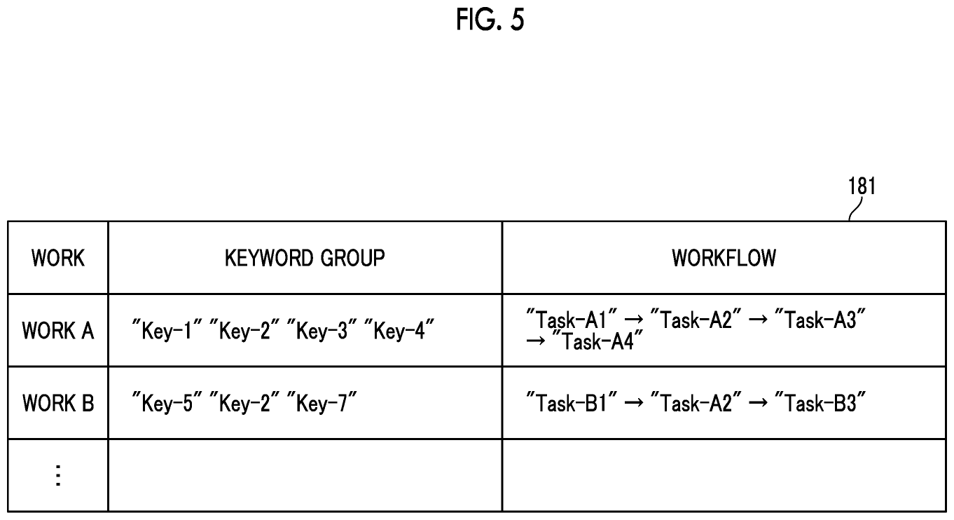

FIG. 5 is a diagram showing an example of a management table used for managing work. In a management table 181 shown in FIG. 5, the name of the work, a keyword group, and a workflow showing the execution procedure of the tasks in the work (described as “workflow” in FIG. 5) are registered in association with each other for each work to be managed. Here, the task constituting the work is the same as the process executed by the extended function shown in FIG. 4, and each task is given the same name as the process having the same content. The keyword group is a set of keywords associated with each process corresponding to each task constituting the work in the management table 171 of FIG. 4. For example, “Work A” includes four processes “Task-A1”, “Task-A2”, “Task-A3”, and “Task-A4”. Therefore, the keywords “Key-1”, “Key-2”, “Key-3”, and “Key-4” of the respective processes shown in FIG. 4 are included in the keyword group of “Work A”. The management table 181 is stored and preserved in, for example, the storage device 104 shown in FIG. 1.

Further, in FIG. 5, the workflow of each work shows the tasks constituting the work by connecting with arrows in the order of execution. For example, “Work A” is performed by executing the four processes of the process “Task-A1”, the process “Task-A2”, the process “Task-A3”, and the process “Task-A4” in this order. Therefore, the workflow is described as “Task-A1”, “Task-A2”, “Task-A3”, “Task-A4”.

Operation of Information Processing Apparatus 10

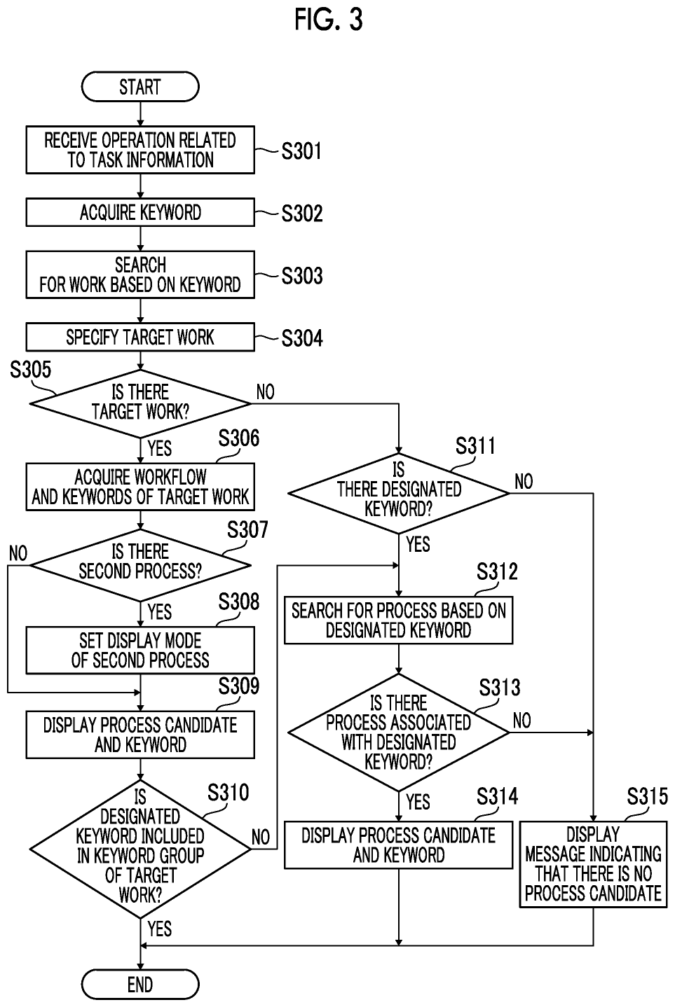

FIG. 3 is a flowchart illustrating an operation related to display of the UI screen by the information processing apparatus 10. In advance, it is assumed that the UI screen as shown in FIG. 7 is displayed on the display device 20. Note that, since the task information is not input to the input field 161 initially, nothing is displayed in both the input field 161 and the process candidate display field 162.

In a case where the user operates the input device 30 and performs an operation related to the task information on the UI screen, the information processing apparatus 10 receives the operation (S301) and acquires a keyword according to the received operation (S302). As the operation related to the task information, initially, the input of the task information to the input field 161 is performed. In a case where the task information is input to the input field 161, the information processing apparatus 10 receives the input of the task information by the input reception function 110 and extracts the keyword from the input task information by the keyword extraction function 120. Other operations related to the task information include the designation operation of the keyword by the user and the selection operation of the keyword to be excluded from the process target, which will be described later.

Next, the information processing apparatus 10 specifies the process candidate to be displayed in the process candidate display field 162 of the UI screen by the display target specification function 150 using the keyword acquired in S302. First, the information processing apparatus 10 uses the work management function 180 to search for the work corresponding to the keyword acquired in S302 (S303), and specifies the work to be presented to the user (S304). Hereinafter, the work to be presented is referred to as “target work”. Specifically, the information processing apparatus 10 searches for the work of which the keyword group includes the keyword acquired in S302, by referring to the management table 181 shown in FIG. 5, for example. Here, the extracted keyword and the keyword group associated with the work do not necessarily have to completely match. As an example, the keyword group of each work is compared with the extracted keyword, and work having the keyword group with the largest number of matching keywords may be obtained as a search result. For example, a case where the keywords acquired in S302 are “Key-1”, “Key-2”, and “Key-3” is considered. In this case, referring to the management table 181 shown in FIG. 5, three keywords “Key-1”, “Key-2”, and “Key-3” are the matching keywords in the keyword group of the work A. On the other hand, only one keyword “Key-2” is the matching keyword in the keyword group of work B. Therefore, in this case, the work A is obtained as the search result.

Here, the search result is the work with the largest number of matching keywords, but a search method for the work based on the keyword is not limited to the above example, and various methods that specify the work based on the keyword may be used. For example, work with a certain number or more of matching keywords or work having a keyword group with a certain percentage or higher of matching keywords may be obtained as the search result. Further, the number of work obtained as the search result may be plural. For example, in the above example, a case where the keywords acquired in S302 are “Key-1”, “Key-2”, and “Key-5” is considered. In this case, referring to the management table 181 shown in FIG. 5, two keywords “Key-1” and “Key-2” are the matching keywords in the keyword group of the work A. On the other hand, two keywords “Key-2” and “Key-5” are the matching keywords also in the keyword group of the work B. Therefore, in this case, both the work A and the work B are obtained the search results.

In a case where the target work is specified as described above (YES in S305), the information processing apparatus 10 acquires a workflow and keywords of the target work (S306). The workflow and the keywords may be acquired, for example, from the management table 181 shown in FIG. 5.

Next, the information processing apparatus 10 uses the display target specification function 150 to specify, among tasks included in the workflow of the target work, a task of which the associated keyword does not correspond to the keyword acquired in S302. For example, in the above example, a case where the keywords acquired in S302 are “Key-1”, “Key-2”, and “Key-3” and the work A is the target work is considered. The relationships between the work, the tasks, and the keywords are based on the management tables 171 and 181 shown in FIGS. 4 and 5. In this case, the workflow of the work A includes the task “Task-A1” associated with the keyword “Key-1”, the task “Task-A2” associated with the keyword “Key-2”, the task “Task-A3” associated with the keyword “Key-3”, and the task “Task-A4” associated with the keyword “Key-4”. Among the keywords, the keyword “Key-4” associated with the task “Task-A4” does not correspond to the keyword acquired in S302. In other words, the tasks “Task-A1”, “Task-A2”, and “Task-A3” correspond to the keywords acquired in S302, and the task “Task-A4” does not correspond to the keyword acquired in S302.

Here, among the processes included in the target work, the process corresponding to the keyword acquired in S302 is the first process. On the other hand, the process that does not correspond to the keyword acquired in S302 is the second process. In a case where the processes included in the target work include the second process, the information processing apparatus 10 sets a display mode of the second process to be different from a display mode of the first process (S307, S308).

Next, the information processing apparatus 10 uses the display control function 160 to set the process included in the target work as a process candidate, and displays the process candidate and a keyword associated with the process on the UI screen (S309). In a case where there is a process candidate of the second process, the process candidate and the keyword of the second process are displayed in the display mode set in S308. Then, the information processing apparatus 10 determines whether or not the keyword designated by the designation operation of the keyword performed by the user is included in the keyword group of the target work. Initially, since the designation operation of the keyword performed by the user is not received, the determination is omitted and is treated as YES in S310. Therefore, the operation of the information processing apparatus 10 ends.

In the above operation example, it is assumed that the task information is input to the input field 161 as an initial operation on the UI screen by the user in S302. As described above, in a case where the task information is input, the keyword is extracted from the input task information, the target work is specified, and the process candidate and the extracted keyword are displayed in the process candidate display field 162. At this time, since the task information is displayed in the input field 161, the user may perform the designation operation of the keyword or the selection operation of the keyword to be excluded from the process target with respect to the displayed natural sentence of the task information. Therefore, next, as the operation related to the task information of the user, a case where the designation operation of the keyword and the selection operation of the keyword to be excluded from the process target are performed will be described.

In a case where the designation operation of the keyword is performed, the information processing apparatus 10 receives the operation by the keyword designation reception function 130 (S301) and acquires the designated keyword (S302). In a case where the selection operation of the keyword to be excluded from the process target is performed, the information processing apparatus 10 receives the operation by the keyword selection reception function 140 (S301) and acquires the selected keyword (S302). Next, the information processing apparatus 10 specifies the target work and the process candidate to be displayed in the process candidate display field 162 of the UI screen by the display target specification function 150 using the keyword acquired in S302 (S303 to S306).

Here, the keyword acquired in S302 is initially the keyword extracted from the input task information, but in this operation, the keyword designated by the designation operation is added to, and the keyword selected by the selection operation is excluded from the keyword extracted from the task information. After the process candidate is specified, the information processing apparatus 10 displays the specified process candidate and the keyword on the process candidate display field 162 of the UI screen (S307 to S309).

Next, the information processing apparatus 10 determines whether or not the keyword designated by the designation operation of the keyword performed by the user is included in the keyword group of the target work. In a case where the designated keyword is included in the keyword group of the target work (YES in S310), the operation of the information processing apparatus 10 ends. On the other hand, in a case where the designated keyword is not included in the keyword group of the target work (NO in S310), the information processing apparatus 10 searches for the process associated with the designated keyword regardless of the target work (S312). The search for the process is performed, for example, with reference to the management table 171 shown in FIG. 4.

In a case where there is a process associated with the designated keyword (YES in S313), the information processing apparatus 10 sets the obtained process as the process candidate, and displays the process candidate and the keyword associated with the process on the UI screen (S314). On the other hand, in a case where there is no process associated with the designated keyword (NO in S313), the information processing apparatus 10 displays a message indicating that there is no process candidate corresponding to the designated keyword, on the UI screen (S315). The process candidate and the keyword corresponding to the designated keyword obtained regardless of the target work may be displayed in a display mode different from the display mode of the process candidate and the keyword as the first process or the second process.

In the above, the operation in a case where there is a target work is described. Next, an operation in a case where there is no target work for the keyword acquired in S302 (NO in S305) will be described. In this case, the information processing apparatus 10 determines whether or not there is a keyword acquired by the designation operation of the keyword in S302. In a case where there is a designated keyword (YES in S311), the information processing apparatus 10 searches for the process associated with the designated keyword regardless of the target work (S312). Then, in a case where there is a process associated with the designated keyword (YES in S313), the information processing apparatus 10 sets the obtained process as the process candidate, and displays the process candidate and the keyword associated with the process on the UI screen (S314). In contrast, in a case where there is no process associated with the designated keyword (NO in S313), the information processing apparatus 10 displays the message indicating that there is no process candidate corresponding to the designated keyword, on the UI screen (S315). Further, in a case where there is no keyword acquired by the designation operation of the keyword in S302 (NO in S311), the information processing apparatus 10 displays the message indicating that there is no process candidate corresponding to the designated keyword, on the UI screen (S315).

Display Example of UI Screen

The display of the UI screen will be further described with reference to FIG. 7. The UI screen shown in FIG. 7 shows a state in which the task information is input to the input field 161 and the process candidates based on the keywords extracted from the input task information are displayed in the process candidate display field 162. In the input field 161, a natural sentence of the input task information “the invoice is approved and printed. In a case where there are any deficiencies, the invoice is returned to the claimant by mail.” is displayed. In this task information, “invoice”, “approval”, “print”, and “mail” are keywords extracted by the keyword extraction function 120 of the information processing apparatus 10. In the example shown in FIG. 7, the text strings corresponding to the extracted keywords are surrounded by solid line frames. The input field 161 is provided with a button object 161a displayed as “search for plug-in again”, and in a case where the button object 161a is operated, the search for the process candidates based on the displayed task information is executed again. The button object 161a is operated, for example, by locating a pointer on the button object 161a and performing a mouse click.

In the process candidate display field 162, a set of the process candidate based on the keyword extracted from the task information and the keyword associated with the process candidate is displayed. In the example shown in FIG. 7, a set of the keyword “confirmation of content of invoice” and the process candidates “confirmation of invoice format” and “confirmation of difference in amount between supply and invoice”, a set of the keyword “approval” and the process candidate “seal”, a set of the keyword “print” and the process candidates “print preview” and “print”, and a set of the keyword “mail” and the process candidate “mail” are displayed. These process candidates are the process candidate group included in the target work searched based on the above keywords “invoice”, “approval”, “print”, and “mail”. Each process candidate is displayed as a button object, the button object is operated to activate a software module that realizes the extended function associated with each process, so that the process may be executed. The button object is operated, for example, by locating a pointer on the button object of the process to be executed and performing a mouse click. In the example shown in FIG. 7, two tabs 163 described as “candidate 1” and “candidate 2” are displayed, and it can be seen that in addition to the target work having the process candidate group displayed in the process candidate display field 162 in FIG. 7, another target work having another process candidate group is searched.

Here, each process candidate forming a set with the keywords “approval”, “print”, and “mail” is the first process corresponding to each keyword extracted from the task information. Further, the keyword “confirmation of content of invoice” is included in the keyword group associated with the process of the target work, but is not included in the task information. More specifically, the task information includes the keyword “invoice”, but does not include the keyword “confirmation of content of invoice”. Therefore, the process candidate forming a set with the keyword “confirmation of content of invoice” is the second process.

In the example shown in FIG. 7, in the task information displayed in the input field 161, the keywords extracted from the task information are surrounded by solid line frames. In an actual UI screen, different display modes may be used for each keyword together with or in place of the line frame. For example, different color highlights may be displayed for each keyword, or the text strings of the keywords may be described in different fonts or colors. In this case, for each keyword, the same display mode may be used for displaying the text string of the keyword in the task information displayed in the input field 161 and displaying the keyword forming a set with the first process displayed in the process candidate display field 162. For example, in the example shown in FIG. 7, with respect to the text string of the keyword “approval” in the task information in the input field 161 and the keyword “approval” displayed in the process candidate display field 162, the text string of the keyword “print” in the task information in the input field 161 and the keyword “print” displayed in the process candidate display field 162, and the text string of the keyword “mail” in the task information in the input field 161 and the keyword “mail” displayed in the process candidate display field 162, the same color highlights may be used for each keyword.

In this way, for each keyword, the same display mode is used for the corresponding keywords, so that it is easy to check the first process that is the process candidate corresponding to the keyword in the task information. Further, it is easy to specify the second process that is the process candidate that does not correspond to the keyword in the task information.

In the example shown in FIG. 7, since a text string corresponding to the keyword “confirmation of content of invoice” is not included in the task information, there is no part having the same display mode as the keyword “confirmation of content of invoice” in the task information. Therefore, it can be seen that the process candidate forming the set with the keyword “confirmation of content of invoice” is the second process.

Next, the display of the UI screen in a case where the designation operation of the keyword is performed by the user will be described. In the example shown in FIG. 7, a keyword “return” other than the keyword extracted by the information processing apparatus 10 in the task information displayed in the input field 161 is the keyword designated by the user. In FIG. 7, the text string “return” in the task information displayed in the input field 161 is surrounded by a broken line frame. In a case where the keyword is designated by the user and the button object 161a is operated, the process candidate is specified based on the designated keyword and displayed in the process candidate display field 162.

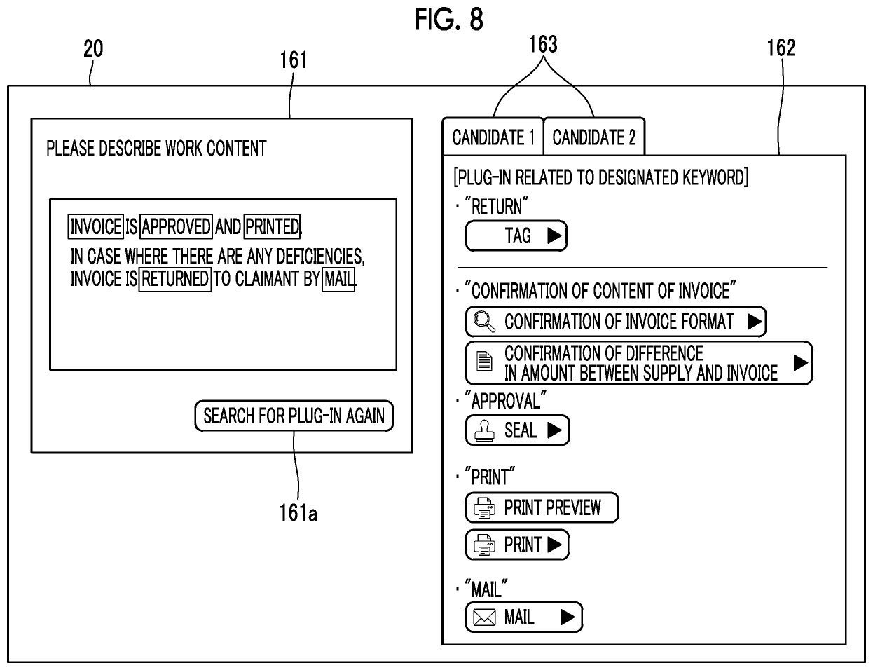

FIG. 8 is a diagram showing a display example of the UI screen in a case where the designation operation of the keyword is performed by the user. In the example shown in FIG. 8, the text string “return” designated as the keyword of the task information displayed in the input field 161 is surrounded by a solid line frame. Then, in the process candidate display field 162, a set of the designated keyword “return” and the process candidate “tag” associated with the keyword “return” is displayed. The set of the keyword “return” and the process candidate “tag” is displayed separately from the first process and the second process based on the keyword extracted from the task information, such that the set may be identified as the process candidate obtained based on the keyword designated by the user.

Next, display of a presentation reason of the second process will be described. In the example shown in FIG. 7, the set of the keyword “confirmation of content of invoice” and the process candidates “confirmation of invoice format” and “confirmation of difference in amount between supply and invoice” is displayed in the process candidate display field 162 as the second process. In a case where an operation of designating the second process is performed by the user, the information processing apparatus 10 displays the presentation reason of the designated second process on the UI screen by the display target specification function 150 and the display control function 160. The operation of designating the second process may be, for example, an operation in which the user operates the input device 30 and positions the pointer on the second process, or the keyword corresponding to the second process.

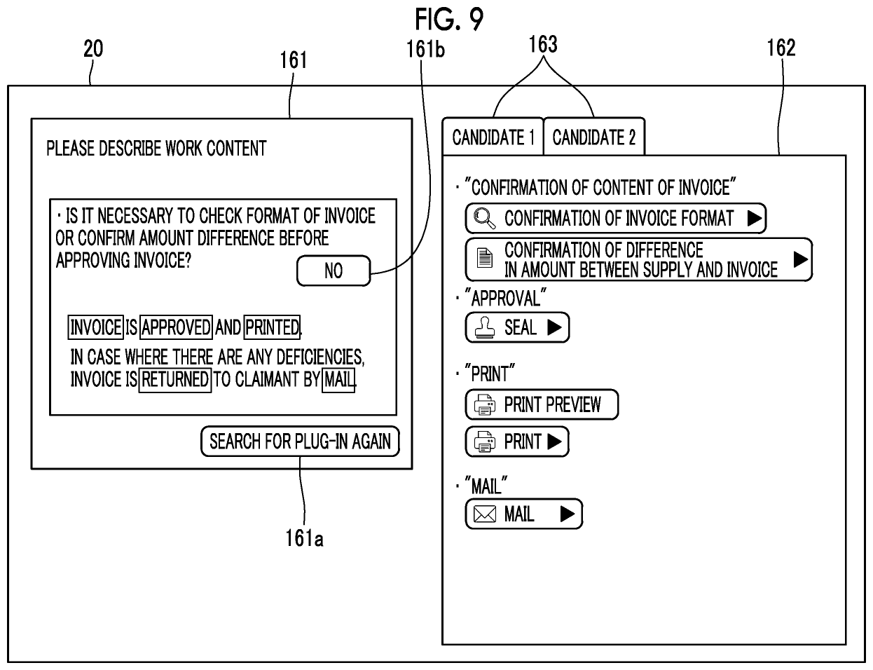

FIG. 9 is a diagram showing a display example of the UI screen displaying the presentation reason of the second process. In the example shown in FIG. 9, the presentation reason of the set of the process candidates “confirmation of invoice format” and “confirmation of difference in amount between supply and invoice”, which are the second processes, and the keyword “confirmation of content of invoice” is displayed in the input field 161. In the example shown in FIG. 9, as the presentation reason, a message sentence “is it necessary to check the format of the invoice or confirm the amount difference before approving the invoice?” is displayed and a button object 161b with the word “NO” is provided. In a case where the button object 161b is operated, the second process, which is the display target of the presentation reason, is excluded from the process candidates and deleted from the process candidate display field 162. A display operation of the message sentence of the presentation reason by the information processing apparatus 10 will be described later.

Next, an annotation display on the UI screen will be described. On the UI screen, in a case where an operation of selecting the button object of the process candidate displayed in the process candidate display field 162 is performed by the user, the information processing apparatus 10 performs an annotation display describing content of the selected process candidate by the display target specification function 150 and the display control function 160. The operation of selecting the button object of the process candidate may be, for example, an operation in which the user operates the input device 30 and positions the pointer on the button object of the process candidate to be displayed with the annotation for a certain period of time or longer.

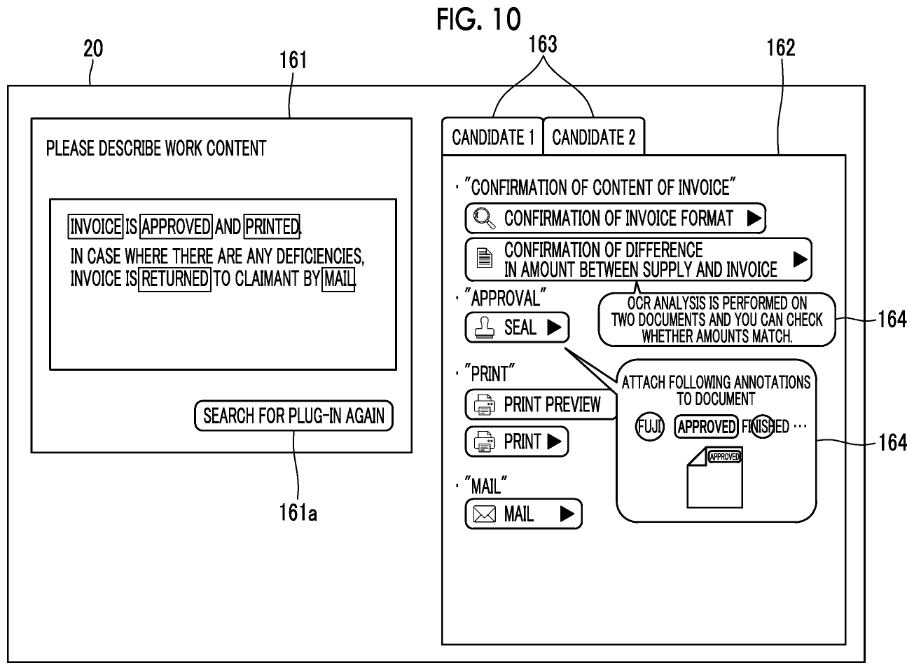

FIG. 10 is a diagram showing a display example of the UI screen on which annotations are displayed. In the example shown in FIG. 10, annotation displays 164 are displayed regarding the process candidate “confirmation of difference in amount between supply and invoice” and the process candidate “seal”. In the annotation display 164, for example, a sentence describing the outline of processing by the selected process candidate is displayed. Further, in a case where the processing by the selected process candidate is processing related to an image, an image used in the processing ora reduced image of that image may be displayed. In the example shown in FIG. 10, the annotation display 164 for the process candidate “confirmation of difference in amount between supply and invoice” displays a message sentence “OCR analysis is performed on two documents and you can check whether amounts match” that is showing the outline of the processing. In addition, the annotation display 164 for the process candidate “seal” displays a message sentence “attach following annotations to document” showing the outline of the processing, images of the annotations, and a reduced image of the document to which the annotation is attached.

Display Operation of Presentation Reason of Second Process

As described with reference to FIG. 9, in a case where the operation of designating the second process is performed by the user, the information processing apparatus 10 displays the presentation reason of the designated second process on the UI screen. A display mode of the presentation reason is not particularly limited, but for example, a display position is set to close to the keyword of the first process related to the second process that for which the presentation reason is displayed, such that a relationship between the second process and the first process related to the presentation reason is easy to be recognized. In the example shown in FIG. 9, since the process is performed before “approval” of the invoice, the presentation reason is displayed at an upper part of the task information in the input field 161.

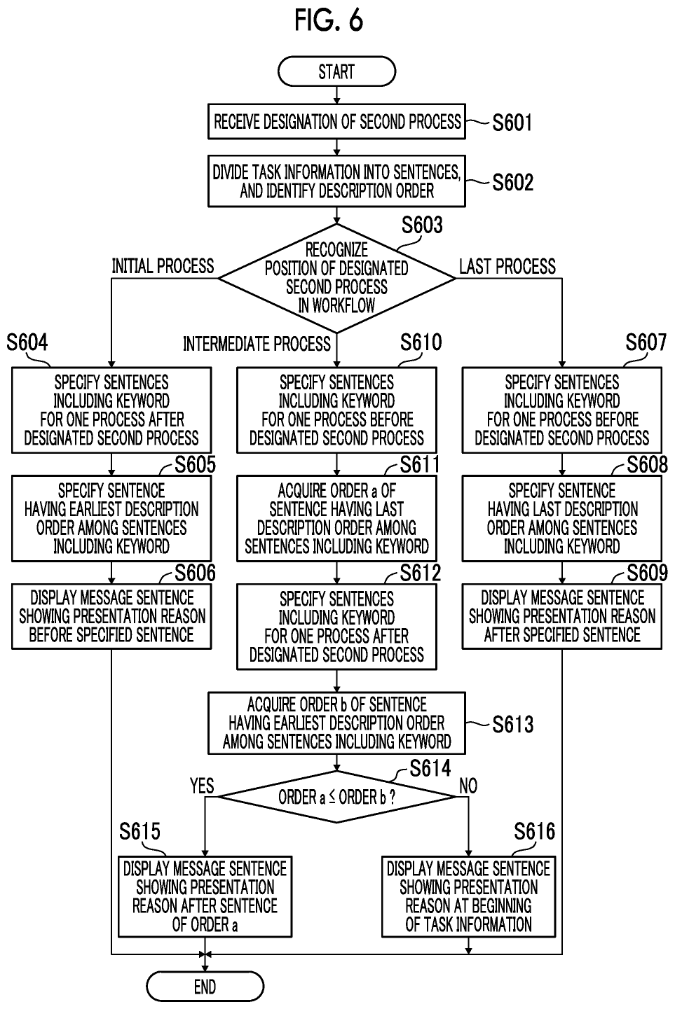

FIG. 6 is a flowchart illustrating the display operation of the message sentence of the presentation reason by the information processing apparatus 10. Here, the work searched from the task information is routine work in which the tasks are sequentially executed in a time-series manner, and according to the task procedure of the work, the confirmation of content of invoice is needed to be performed before the approval of the invoice. In addition, the task information, which is a natural sentence, is described in the order of the processes executed in the work.

In a case where the information processing apparatus 10 receives the operation of designating the second process in the process candidate display field 162 of the UI screen (S601), the information processing apparatus 10 divides the task information input in the input field 161 into sentences, identifies a description order of each sentence in the task information (S602). Then, the information processing apparatus 10 recognizes a position of the designated second process in workflow of the work including the task of the second process designated in S601 (S603). The recognition of the position of the designated second process is performed, for example, by determining whether or not other tasks are set before or after the task of the designated second process in the workflow. Specifically, in a case where no other task is set before the task of the designated second process, the designated second process is an initial process in the workflow. In addition, in a case where no other task is set after the task of the designated second process, the designated second process is the last process in the workflow. Further, in a case where other tasks are set before or after the task of the designated second process, the designated second process is a process executed in the middle of the workflow.

In a case where the designated second process is the initial process in the workflow, the information processing apparatus 10 specifies sentences including a keyword for one process after the designated second process from the task information of the input field 161 (S604). Next, the information processing apparatus 10 specifies a sentence having the earliest description order among the sentences including the keyword that are specified in S604 (S605). Then, the information processing apparatus 10 secures an area before the sentence specified in S605, and displays a message sentence showing the presentation reason of the designated second process in the secured area (S606). Securing the area of the message sentence is performed, for example, by moving backward a display position of each sentence after a position where the area is to be secured.

In a case where the designated second process is the last process in the workflow, the information processing apparatus 10 specifies sentences including a keyword for one process before the designated second process from the task information of the input field 161 (S607). Next, the information processing apparatus 10 specifies a sentence having the last description order among the sentences including the keyword that are specified in S607 (S608). Then, the information processing apparatus 10 secures an area after the sentence specified in S608, and displays the message sentence showing the presentation reason of the designated second process in the secured area (S609).

In a case where the designated second process is an intermediate process in the workflow, the information processing apparatus 10 specifies sentences including the keyword for one process before the designated second process from the task information of the input field 161 (S610). Then, the information processing apparatus 10 acquires an order a in the task information of the sentence having the last description order among the sentences including the keyword specified in S610 (S611). Further, the information processing apparatus 10 specifies sentences including the keyword for one process after the designated second process from the task information of the input field 161 (S612). Then, the information processing apparatus 10 acquires an order b in the task information of the sentence having the earliest description order among the sentences including the keyword specified in S612 (S613).

Next, the information processing apparatus 10 compares the order a acquired in S611 with the order b acquired in S613. In a case where a value of the order a is equal to or smaller than a value of the order b (YES in S614), in other words, in a case where the orders indicated by the order a and the order b are the same or the order a is earlier, the information processing apparatus 10 secures an area after the sentence of the order a, and displays the message sentence showing the presentation reason of the designated second process in the secured area (S615). On the other hand, in a case where the value of the order a is larger than the value of the order b (NO in S614), in other words, in a case where the value of the order b is earlier, the information processing apparatus 10 secures an area at the beginning of the task information, and displays the message sentence showing the presentation reason of the designated second process in the secured area (S616).

As mentioned above, the exemplary embodiment of the present invention is described, but the technical scope of the present invention is not limited to the exemplary embodiment. For example, in the above exemplary embodiment, the process of the task included in the target work, which is the work to be presented searched based on the keyword, but not included in the task corresponding to the keyword extracted from the task information is set to the second process. On the other hand, other processes estimated from the target work by various methods other than the above may be specified as the second process. As an example, a use history of the user in a system that executes the task related to the work is referred to, and in a case where there is a task that is not included in the target work but is executed in performing the target work, a process of the task may be set as the second process. In addition, as another example, the use history of the user in the system that executes the task related to the work is referred to, and in a case where there is the task that is not included in the target work but is executed together with the first process, which is the process of the task corresponds to the keyword extracted from the task information, the process may be set as the second process.

Further, in the above exemplary embodiment, in a case where the designation operation of designating the text string for the task information displayed in the input field 161 of the UI screen is performed, the text string designated by the designation operation is added as anew keyword to the keywords extracted from the task information earlier, and the target work is searched (see FIG. 3). Here, in a case where there is a process associated with the designated new keyword, a set of the keyword and the process may be registered in the management table 181 as the process and the keyword of the task included in the target work. In addition, the set of the keyword and the process may be registered in the management table 181 as the process and the keyword of the task included in the target work, on the condition that the process is executed by the user, not at the time the process associated with the designated keyword is obtained.

Further, in the above exemplary embodiment, the task information, which is information showing the content of the task related to the work, is input as a natural sentence. However, the input of the task information is not limited to the input as a natural sentence. For example, a user interface may be used in which the content of the task or the type of the work including a plurality of tasks is displayed as a menu, and the user inputs the task information by selecting the task or the work from the displayed menu. Further, regarding the above designation operation of the keyword, a user interface may be used in which keywords that can be designated are displayed in the menu, and the user may designate a keyword by selecting the keyword from the displayed menu instead of the operation of designating the text string of the task information that is a natural sentence. In addition, various modifications or alternative configurations without departing the scope of the technical concept of the present invention are included in the present invention.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising a processor configured to:
receive an input of content of work including a plurality of processes; and
display a first process corresponding to the input content of the work and a second process estimated from work related to the content of the work and not included in the content of the work, on a display device.

2. The information processing apparatus according to claim 1, wherein the processor is configured to:
in a case where, in a use history of a user, a process different from a process to be executed in the work is executed regarding the work related to the content of the work, set the executed process as the second process.

3. The information processing apparatus according to claim 1, wherein the processor is configured to:
set a process not included in the first process and executed together with the first process, as the second process based on a use history of a user.

4. The information processing apparatus according to claim 1, wherein the processor is configured to:
display a reason why the second process is being displayed.

5. The information processing apparatus according to claim 1, wherein the processor is configured to:
extract a keyword from the input content of the work and receive a designation of a keyword other than the extracted keyword; and
set a process associated with the extracted keyword as the first process and a process associated with the designated keyword as the second process.

6. The information processing apparatus according to claim 1, wherein the processor is configured to:
receive a designation of a keyword extracted from the input content of the work; and
remove a process associated with the designated keyword from the display.

7. A non-transitory computer readable medium storing a program causing a computer to execute a process, the process comprising:
receiving an input of content of work including a plurality of processes; and
specifying a first process corresponding to the input content of the work and a second process estimated from the work and not included in the content of the work.

8. An information processing apparatus comprising:
means for receiving an input of content of work including a plurality of processes; and
means for displaying a first process corresponding to the input content of the work and a second process estimated from work related to the content of the work and not included in the content of the work, on a display device.
